(19) United States
(12) Patent Application Publication
(10) Pub. No.: US 2011/0115591 A1
(43) Pub. Date: May 19, 2011

(54) Power Adapter Having a Heating and Heat Dissipating Device

(75) Inventor: Wen-Hung Huang, Taipei County (TW)

(73) Assignee: HANNSPREE, INC., Taipei City (TW)

(21) Appl. No.: 12/644,611

(22) Filed: Dec. 22, 2009

(30) Foreign Application Priority Data
Nov. 16, 2009 (CN) 200910211924.5

(51) Int. Cl. H01F 27/08

(52) U.S. Cl. 336/55

(57) ABSTRACT

The present invention provides a power adapter having a heating and heat dissipating function. The power adapter comprises an outer shell, an inner shell, a power source input terminal and a power source output terminal. The outer shell further comprises a recessed slide. The inner shell includes a stopper, an opening, a transformer and a heating device. The outer shell could slide along the recessed slide. While the outer shell moves from a first position to a second position, the heating device could be revealed. The user could put anything that need to be heated or warmed up on the heating device.

### FIELD OF THE INVENTION

The invention relates to a power adapter. More particularly the invention relates to a power adapter having a heating and heat dissipating function.

### BACKGROUND

Power adapter changes the voltage (or the current) of an electrical power source and usually combined with other components to create a power supply. A typical power adapter usually includes an outer shell, an electrical power transformer and a rectification circuit. Conventionally, in the view of output, there are two types of power adapter: an AC output power adapter and a DC output power adapter. On the other hand, in the view of structure, the power adapter could be further divided into individual type and plug-in type.

There are still some drawbacks of the conventional inventions. The conventional power adapter is sealed in an enclosure insulating container, which can not only prevent the users from touching the inner electrical structure or transformer's wires, but also blocks the heat inside the container. Commonly, the power adapter would generate enormous heat during operations. Thus, the protecting casing would block the heat inside the container. For conventional power adapter heat dissipating and heat recovery would be the major concern for the design. The great deal heat accumulates would heat up the structure above the transformer or the wires and the container would be easily deteriorated.

In view of the problems existed in the prior art and for solving them concurrently, the inventor proposes a method for enabling a power adapter with a heating and heat dissipating function, on the basis of research and development for many years as well as much practice experience, used as the realizing way and basis to solve above problems.

### SUMMARY OF THE INVENTION

The present invention provides a power adapter with a heating and heat dissipating function. The present invention also comprises a structure that reuses the heat generated from the transformer and then transfers it into heating purpose. The recycle of the heat may also benefit in heat dissipating.

The present invention comprises at least one outer shell, an inner shell, a power source output terminal and a power source input terminal. The outer shell further comprises a recessed slide and the inner shell attaches inside the outer shell. The inner shell further included a stopper, an opening, a transformer, a heating device, an input and an outlet. The stopper of the inner shell could actuate contact with the slide and the outer shell substantially pulling in the direction along the slide. When the outer shell hauls along the slide the heating device of the inner shell reveals. The user could put the objects that need to be heated or warm up on the heating device. The power source input terminal plugs into the input and the transformer draw out the determined power through the outlet. The terminals are electrically engage with the transformer. The heating device, which is made of a high thermal conductivity material, further comprises a heating plate, a casing and a spring. The casing is set above the transformer and the spring is then placed in the casing. The heating plate should be sized in order to match the top opening of the inner shell. One end of the spring is attached to the heat dissipating plate and the other end is attached to the transformer. When using the power adapter as a heater, the user could just pull open the outer shell and put the predetermined objects on the heating plate. A primary object of the present invention is to provide a power adapter that could effectively dissipate heat by opening the outer shell.

Another object of the present invention is to provide a power adapter that could effectively reuse the heat generated from the transformer.

Another object of the present invention is to increase the heat dissipating efficiency of the power adapter.

It is yet another object of the present invention to provide an easy-to-use heating device.

A further comprehension and understanding of the technical features and effects of the present invention may be acquired by referring to the embodiments, taken in conjunction with the following detailed description thereof.

### BRIEF DESCRIPTION OF DRAWINGS

FIG. 1A is an elevational view of a power adapter at the first position according to one preferred embodiment of the present invention;

FIG. 1B is an elevational view of a power adapter at the second position according to one preferred embodiment of the present invention;

FIG. 1C is an exploded view of a power adapter according to one preferred embodiment of the present invention;

FIG. 2A is a cross-sectional view of the power adapter at the first position according to one preferred embodiment of the present invention;

FIG. 2B is a cross-sectional view of the power adapter at the second position according to one preferred embodiment of the present invention;

FIG. 3 is an elevational view showing the power adapter according to another preferred embodiment of the present invention.

### DETAILED DESCRIPTION

In the following, power adapter having a heating and heat dissipating function according to the preferred embodiment of the present invention will be described with reference to related drawings. For better understanding, identical elements will be indicated with like numerals in the following embodiments.

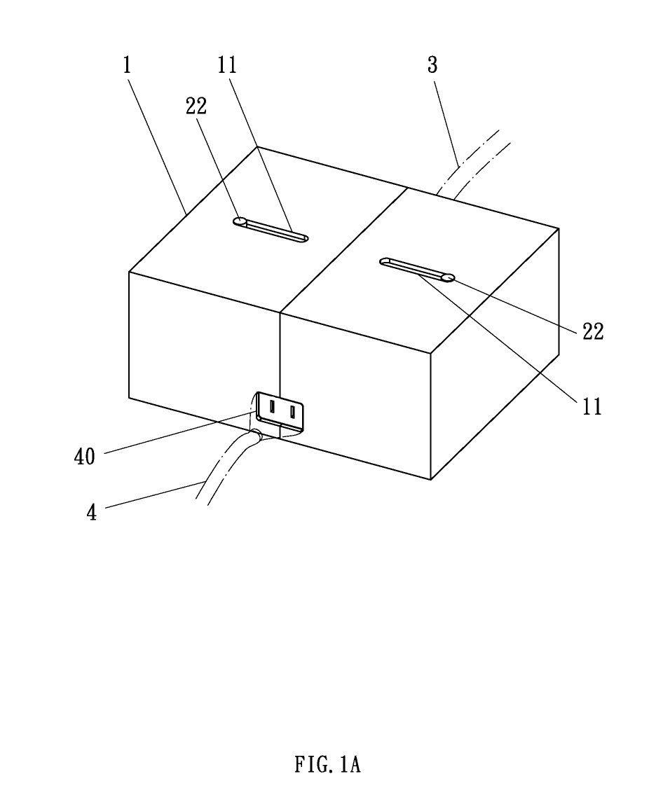

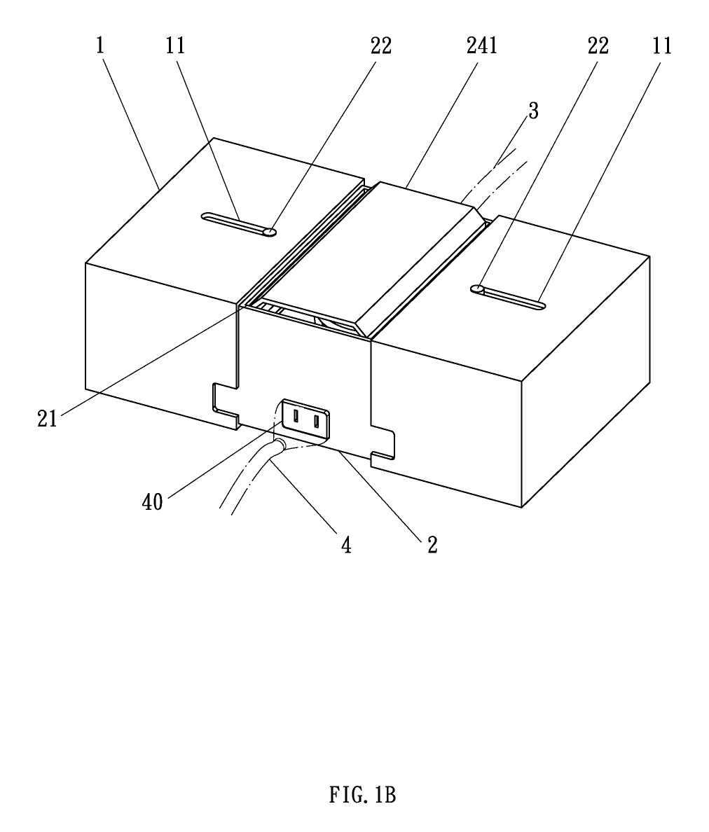

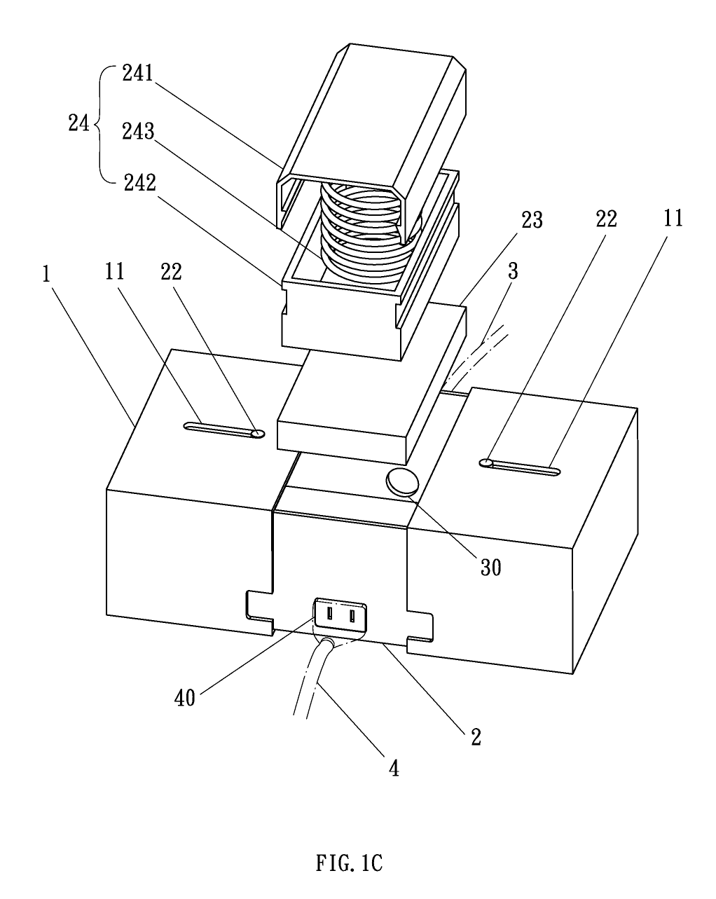

Referring to FIG. 1A-1C, a power adapter according to a preferred embodiment of the present invention is illustrated. The power adapter comprises an outer shell 1, an inner shell 2, a power source output terminal 3 and a power source input terminal 4. The preferred embodiment of the present invention is a left-right symmetrical structure (but not limited to). The outer shell 1 has at least one recessed slide 11 and in this preferred embodiment shows two recessed slides. The outer shell 1 is also made of an insulating material. The inner shell 2 has an opening 21, a stopper 22, a transformer 23, a heating device 24, an input 40 and an outlet 30. The opening 21 located on the top wall of the inner shell 2 and the inner shell 2 shows a semi-enclosed structure. The stopper 22 is designed to match the recessed slide 11 and the major object of the stopper 22 is to restrict the position of the outer shell 1. Apply a force respectively on either side of the left-right symmetrical structure and the outer shell 1 will move from the first position (FIG. 1A) to the second position (FIG. 1B). By changing the length and the directions of the recessed slide 11 or the position of the stopper 22 could restrict the shift length and direction of the outer shell. The power source output terminal 3 and the power source input terminal 4 are electrically connected through the outlet 30 and the input 40, respectively. The output power then applied to a computer or the like.

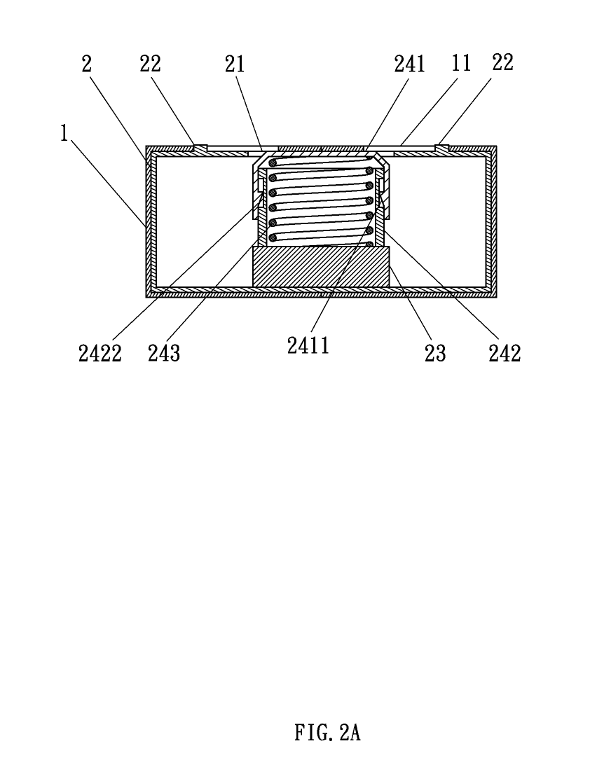

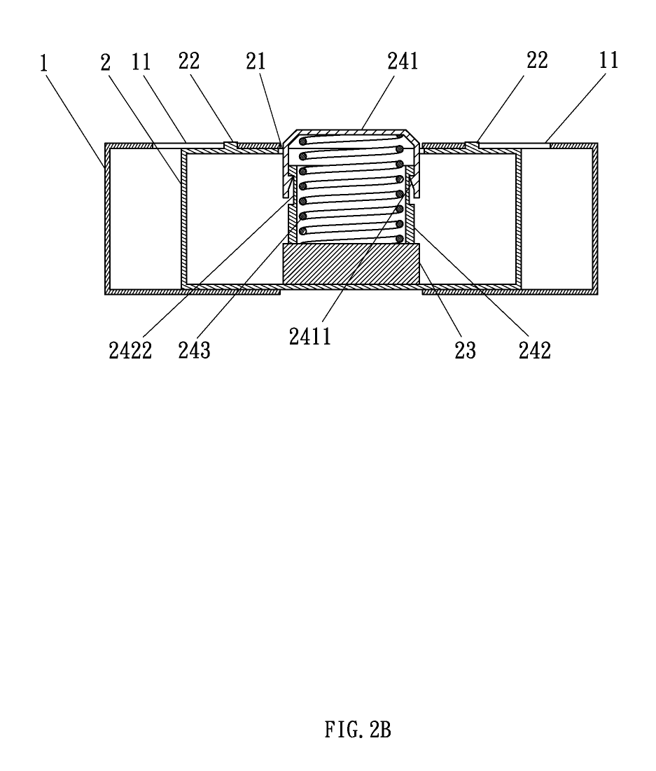

The heating device 24 is placed in the inner shell 2 and further comprises a heat dissipating plate 241, a casing 242 and a spring 243. The heat dissipating plate 241 is made of high heat conductivity material such as metal and positioned in the opening 21. The casing 242 is set above the transformer 23 and the spring 243 is then placed inside the casing 242. One end of the spring 243 is attached to the heat dissipating plate 241 and the other end is attached to the transformer 23. The primary object of the spring 243 is to transfer the heat from the transformer 23 to the heat dissipating plate 241 (referred to FIG. 2A). Furthermore the spring 243 could be made of high impedance material. In this way one end of the spring 243 could electrically connected to the transformer 23. While the current carries through the spring 243, the spring itself would generate heat and therefore transfer the heat to the heat dissipating plate 241.

FIG. 2A and FIG. 2B respectively illustrated the first and the second position according to one preferred embodiment of the present invention. According to FIG. 2A, when the power adapter is not operates as a heater, the outer shell 1 and the inner shell 2 maintain in the first position. In the state of the first position, the inner shell 2 is sleeved inside the outer shell 1 and the heating dissipating plate 241 is suppressed at the third position. At the third position, the spring 243 has been compressed and the elastic restoring force of the spring 243 becomes larger. When the power adapter operates as a heater, the user pulls the outer shell 1 along the recessed slide 11. Due to the stopper 22, the outer shell 1 will stop at the second position. Meanwhile the storing force of the spring 243 pushes the heat dissipating plate 241 up. Thus, the heat dissipating plate 241 moves from the third position to the fourth position. In this way, the predetermined objects that need to be heated or warmed up could easily place on the heat dissipating plate 241.

Wherein, the heat dissipating plate 241 further comprises a protrusion member 2411 and the casing 242 further comprises a concave member 2422. When the protrusion member 2411 is received and fills by the concave member 2422, the outer shell 1 presents at the first position and the heat dissipating plate 241 locates at the third position. The major object for the protrusion member 2411 and the concave member 2422 is to restrict the heat dissipating plate 241 at the third position. The protrusion member and concave member could be rearranged to any similar structure that could achieve the above object. While the outer shell 1 is at the second position, the heat dissipating plate 241 rises to the fourth position. The protrusion member 2411 and the concave member 2422 will restrict the heat dissipating plate 241 at the forth position. With the restriction of the protrusion member 2411 and the concave member 2422 had made, the heat dissipating plate 241 could only move between the third position and the forth position. Also the restriction could prevent the unexpected restored force of the spring 243 from pushing the heat dissipating plate 241 out the power adapter. Moreover, the heat dissipating plate 241 could further include a slant on either side of it. The slant would benefit when the outer shell 1 moves from the second position to the first position. Due to the slants, the heat dissipating plate 241 could be easily moved from the fourth position back to the third position.

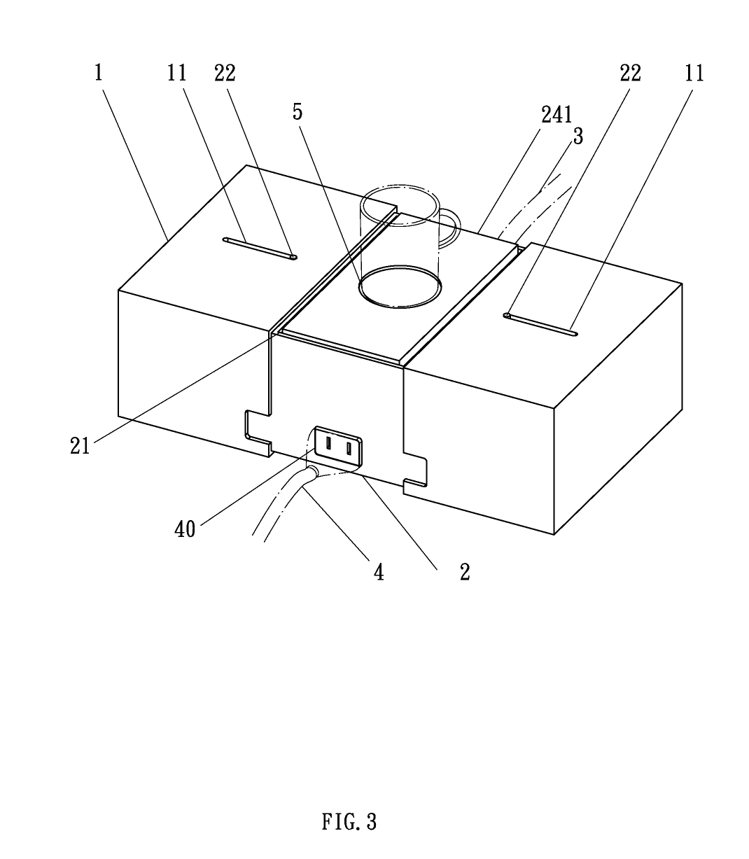

FIG. 3 is another preferred embodiment according to the present invention. This preferred embodiment further includes a hollow area 5 on the heat dissipating plate 241. The hollow area 5 could be use as a cup holder. The major object of the hollow area 5 is to improve stability, convenience and safety of the power adapter.

Representative advantages offered by this invention may be briefly summarized below.

(1) Effectively reuse the heat produced by the power adapter and transferred it into a heat source that could be use to warm up or heat specific object.

(2) In the process of reuse, this invention also increases the heat dissipating efficiency of the power adapter.

(3) The power adapter further comprises an easy heating function.

The present invention has been demonstrated herein by reference to the preferred embodiments. However, it is understood that the embodiments are not intended to limit the scope of the present invention, which is defined only by the appended claims. Therefore, any changes or modifications that are based on the contents disclosed herein and do not depart from the spirit of the present invention should be encompassed by the appended claims.

1. A power adapter having a heating and heat dissipating function, comprising:
an inner shell having an opening;
a transformer, disposed inside the inner shell;
a heating device having a heating dissipating plate and a spring, wherein the heat dissipating plate is disposed in the opening of the inner shell, and the ends of the spring is connected between the transformer and the heat dissipating plate respectively; and
at least one outer shell, wherein the outer shell is relatively movable between a first position and a second position; when the outer shell and the inner shell present at the first position, the outer shell covers the opening of the inner shell and suppresses the heat dissipating plate to a third position, the heat dissipating plate compresses the spring and the spring further comprises an elastic restoring force; when the outer shell and the inner shell present at the second position, the opening of the inner shell is uncovered, and the elastic restoring force pushes the heat dissipating plate up from the third position to a fourth position.

2. A power adapter having a heating and heat dissipating function according to claim 1, wherein the outer shell is made of an insulating material.

3. A power adapter having a heating and heat dissipating function according to claim 1, wherein the inner shell further comprises a stopper and the outer shell includes a recessed slide which matches the stopper.

4. A power adapter having a heating and heat dissipating function according to claim 2, wherein the heating device further comprises a casing and the spring is placed inside the casing.

5. A power adapter having a heating and heat dissipating function according to claim 4, wherein the heat dissipating plate comprises at least one protrusion member; the casing further comprises a concave member that matches the protrusion member of the heat dissipating plate and the protrusion member movable along the concave member.

6. A power adapter having a heating and heat dissipating function according to claim 4, wherein the either side of the heat dissipating plate comprises a slant.

7. A power adapter having a heating and heat dissipating function according to claim 1, wherein one end of the spring is electrically connected to the transformer.

8. A power adapter having a heating and heat dissipating function according to claim 1, wherein the heat dissipating plate further comprises a hollow area.
